(19) United States
(12) Patent Application Publication
(10) Pub. No.: US 2018/0143027 A1
(43) Pub. Date: May 24, 2018

(54) DYNAMIC ROUTE PLANNING FOR DEMAND-BASED TRANSPORT

(71) Applicant: Microsoft Technology Licensing, LLC, Redmond, WA (US)

(72) Inventors: Benny Schlesinger, Ramat Hasharon (IL); Yuval Pinchas Borsutsky, Rishon Le-zion (IL); Eldar Cohen, Tel Aviv (IL); Keren Damari, Tel Aviv (IL)

(21) Appl. No.: 15/358,332

(22) Filed: Nov. 22, 2016

(51) Int. Cl. G01C 21/34; G08G 1/0968; G08G 1/123; G06Q 50/30

(52) U.S. Cl. CPC G01C 21/3415; G01C 21/343; G06Q 50/30; G08G 1/123; G08G 1/096844

(57) ABSTRACT

A system demand-based transport includes a reservation intake engine that receives rider transit requests from various computing devices. Each rider transit request specifies at least one stop request associated with one a plurality predesignated stop locations. Responsive to receiving one or more of the rider transit requests, a route planner plans a transportation route that includes planned stops selected from the predesignated stop locations.

### BACKGROUND

Private transit providers generally offer personal on-demand transit services for individuals and/or small groups of people. Public transit providers, in contrast, operate based on predefined routes and schedules designed to serve a large number of people. Due to systematic inefficiencies, private transit services are often prohibitively expensive, especially for daily use. In contrast, public transit services may be inconvenient for riders due to strict adherence to predefined routes. For example, a vehicle may stop at a designated route stop even when there are no riders who intend to exit or board the vehicle at the designated stop. This can result in a less-than-optimal route and/or longer overall route time that inconveniences riders.

### SUMMARY

Implementations described and claimed herein address the foregoing by providing methods and systems for dynamic route planning to service demand-based transport. In one implementation, a method for providing demand-based transport includes receiving one or more rider transit requests from various computing devices. Each received rider transit request specifies at least one stop request associated with one of a plurality of predesignated stop locations. The method further includes dynamically planning a transportation route to service the received rider transit requests. The transportation route includes planned stops selected from the predesignated stop locations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other implementations are also described and recited herein.

### BRIEF DESCRIPTION OF THE DRAWINGS

FIG. 1 illustrates an example demand-based transport system that implements dynamic route planning for private and/or public transit.

FIG. 2 illustrates dynamic route planning by an example demand-based transport system.

FIG. 3 illustrates a dynamically-implemented route change by an example demand-based transport system.

FIG. 4 illustrates example operations for route planning according to an example demand-based transport system.

FIG. 5 illustrates an example schematic of a computing device suitable for implementing aspects of a demand-based route transport system according to the herein described technology

### DETAILED DESCRIPTION

The herein disclosed technology provides demand-specific planning of customized transit routes in order reduce distance and/or travel time for riders and thereby eliminate inconveniences posed by traditional forms of public transit, such as stops at and detours to designated locations where no riders wish to board or exit a vehicle. In some implementations, the customized routes may be tailored to provide other additional benefits such as to reduce driver staffing, traffic (e.g., in specific areas), and to reduce resource consumption, traffic, and system-wide operational costs.

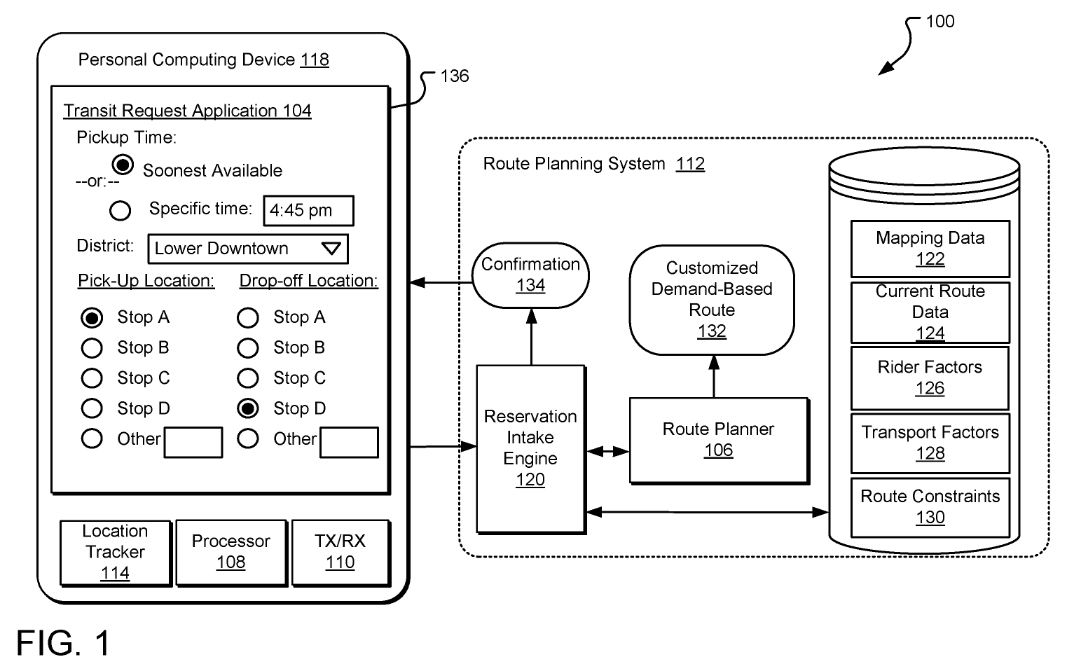

FIG. 1 illustrates an example demand-based transport system 100 that implements dynamic route planning for private and/or public transit, such as by providing customized routes and/or dynamic route alterations responsive to rider transit request(s). The dynamic demand-based transport system 100 includes a route planning system 112 that interacts with one or more computing devices (e.g., a personal computing device 118) to receive and respond to rider transit requests, dynamically create customized transit routes, and/or update existing transit routes responsive to such request(s).

The route planning system 112 includes at least a reservation intake engine 120 and a route planner 106. These and other components of the route planning system 112 may exist within a single network or may be distributed across any combination of networks, servers, personal devices, etc. In one implementation, the route planning system 112 resides on a centralized server. In another implementation, the various aspects of the route planning system 112 are integrated on personal devices that interact directly (e.g., peer-to-peer) to assess rider demand and to dynamically plan and update various transportation routes.

In general, the reservation intake engine 120 receives rider transit requests and associated data (e.g., “transit request data”) from computing devices such as the personal computing device 118. For example, the personal computing device 118 may transmit a rider transit request to the route planning system 112 to request transportation for a user (also referred to herein as a “potential rider”) that is carrying the personal computing device 118.

Transit request data associated with the data transit request may specify various information pertaining to rider-specific parameters for servicing the request (herein referred to as “rider factors”), including without limitation, one or more of a pick-up location, drop-off location, times for pick-up or drop-off, special requests, etc. In one implementation, the transit request data specifies a pick-up and/or drop-off location that corresponds to one of a plurality of predesignated stops associated with a particular vehicle or group of vehicles.

The reservation intake engine 120 intakes transit request data and organizes and and/or appends to such data prior to provisioning the transit request data to the route planner 106. The route planner 106, in turn, uses a plurality of available resources to generate a customized demand-based route 132 for servicing the data transit request, such as by accessing one or more databases including without limitation mapping data 122, current route data 124, rider factors 126, transport factors 128, and route constraints 130.

In general, mapping data 122 refers to mapping information that the route planner 106 can utilize to design a customized route to service received rider transit requests. The current route data 124 includes, for example, routes currently planned and/or in-progress, defined by geographical coordinates and/or maps, planned stops, and corresponding estimated stop times. Rider factors 126 may include rider-specific parameters for servicing each rider transit request, for example, drop-off and pick-up locations, preferred pick-up and/or drop-off times, estimated pick-up and/or drop-off times, and other rider transit data such as rider preferences. For example, a user may optionally set a preference that allows the route planning system 112 to recommend or automatically pick between different routes, such as a preference that specifies that the user prefers to walk to a further-away pick-up location than a closer pick-up location in the event that the walk reduces total travel time between the time that the rider transit request is initiated and a time that the rider is dropped off at a requested destination.

Transport factors 128 indicate transit-specific parameters for servicing each rider request including without limitation estimated route speeds, current vehicle locations, areas serviceable by particular vehicles, known traffic delays (e.g., construction, accidents), etc. In one implementation, the transport factors 128 include transport vehicle identifiers saved in association with a particular geographic area, such as a geographical area defining a region that each transit vehicle is assigned to provide service in. In other implementations, transit vehicles are not specifically associated with a particular geographic area and are, for example, available for dispatch in any geographical area within acceptable driving distance to a location where the vehicle is stored when not in use.

In planning the customized demand-based route 132, the route planner 106 may implement various route constraints 130. Route constraints may be based on rider factors or transport factors. Route constraints based on rider factors include, for example, constraints designed prevent unacceptable slippage in estimated pick-up/drop-off times, constraints that limit the number of passengers to prevent overcrowding, etc. In contrast, route constraints based on transport factors include, for example, constraints designed to efficiently utilize resources such as to ensure each route services at least a threshold number of people, constraints that ensure that drivers can be relieved from duty at a set time, constraints that ensure that a route ends near a set location (e.g., parking garage), etc.

In some implementations, the reservation input engine 120 organizes and/or appends to the transit request data before providing the data to the route planner 106. For example, the reservation intake engine 120 may access vehicle location data (e.g., an example one of the transport factors 128) and/or the current route data 124 to identify and recommend one or more vehicles for servicing a received rider transit request. For example, the reservation input engine 120 may identify one or more vehicles currently near a stop location specified by a received rider transit request or identify one or more vehicles that are scheduled to be near the stop location at a future point in time (e.g., if the rider transit request specifies a future pick-up time). Recommended vehicle(s) may then be provided to the route planner 106 along with the transit request data.

In one implementation, the route planner 106 plans the customized demand-based route 132 to service one or more of a plurality of predesignated stop locations. As used herein, a “predesignated stop location” is a location that the route planning system 112 has designated as a stop where riders may be picked up or dropped off. For example, the route planning system 112 may designate a particular vehicle or group of vehicles to service a set of predesignated stop locations. In some implementations, vehicles may also service some stop locations that are not predesignated. For example, the route planning system 112 may identify stops based on accumulated demand from different personal computing devices and/or rider transit requests. In general, the term “stop location” is herein used to refer to location that may or may not be a predesignated stop location.

After selecting an available vehicle to service a particular rider transit request or group of rider transit requests, the route planner 106 plans the customized demand-based route 132 for the available vehicle. The customized demand-based route 132 includes planned stops, such as planned stops at predesignated stop locations that are associated with or specified by the received transit request data. In one implementation, the customized demand-based route 132 includes planned stops at some predesignated stop locations but intentionally bypasses other predesignated stop locations that are not specified by received transit request data. For example, the transit factors 128 may store a vehicle identifier in association with a plurality of predesignated stop locations (e.g., locations within a geographical area capable of being serviced on a single route). The route planning system 112 may instruct dispatch of a vehicle on a planned route to service a subset of these predesignated stops that are requested at a given point in time. The route planner 112 may, in some implementations, update the customized demand-based route 132 of the vehicle while the vehicle is in transit thereby causing the vehicle to stop at one or more newly-requested stops of the predesignated stop locations.

In one implementation, a default route is initially associated with a particular vehicle and the route planner 106 modifies the default route during initial route planning to generate the customized demand-based route 132. “Initial route planning” refers to, for example, route planning performed responsive to one or more rider transit requests and before a vehicle is initially dispatched to service the customized demand-based route 132. In other implementations, there is no default route. For example, route planning for a vehicle is performed responsive a first received rider transit request of the day and the customized demand-based route 132 is determined exclusively based on received rider transit requests. If multiple rider transit requests are received in close temporal proximity, the initial route planning may plan a route that includes multiple stops to service the requests.

After a vehicle is dispatched to service the customized demand-based route 132, the route planner 106 may continue to dynamically update the planned route to service additional rider transit requests, such as to modify the customized demand-based route 132 to service additional passengers at pick-up and/or drop-off locations near to or along the originally-planned route. As used herein, a route alteration or modification may refer to a change in a planned route course (e.g., a detour) and/or refer to the addition or removal of stops at one or more predesignated stop locations along the planned route.

As mentioned above, the route planner 106 may identify and apply one or more of the route constraints 130 when modifying a route, such as to ensure a quality of service to riders currently associated with a route. For example, the route planner 106 may apply constraints designed to guarantee that a pick-up or drop-off time for a rider remains within a set window (e.g., +/−10 minutes) of an initially-estimated pick-up or drop-off time. These constraints are usable to provide a systematic balance between minimizing travel time and/or distance for each individual rider while still allowing some flexibility to pick-up additional passengers and to provide those passengers with similar time and/or distance guarantees.

In one implementation, actual stop locations on the customized demand-based route 132 are determined exclusively based on rider transport requests. Therefore, riders are not inconvenienced with stops at locations where there are no riders to be picked-up or dropped-off. Additionally, the customized demand-based route 132 may be tailored to minimize time and/or distance with respect to each individual rider transit request. Therefore, riders may not be subjected to long detours to locations that are not of interest to current riders, such as to stops where there are no riders that wish to be picked-up or dropped-off.

In one implementation, the customized demand-based route 132 includes planned stops exclusively at predesignated stop locations (e.g., similar to the traditional “bus stop”). In other implementations, the customized demand-based route 132 includes planned stops at locations that are not predesignated stop locations. For example, different personal devices may interact through a transit request application 104 to provide information for assessing rider demand in an upcoming period. In one implementation, different personal devices may interact between themselves (e.g., peer-to-peer (P2P)) or through a centralized server (e.g., the route planning system 112) to exchange information and to identify a best set of route stops based on current demand. In still other implementations, the demand-based transport system 100 services a mix of predesignated stops and non-predesignated (e.g., rider-specified) stops.

Each individual transit request of the dynamic demand-based transport system 100 originates at a computing device, such as the personal computing device 118. In different implementations, the computing device 118 may take on a variety of forms such as a mobile phone, tablet, personal computer, smart watch, or other computing device, such as a public computing device stationed at a kiosk or predesignated vehicle stop that is available to riders to place transit requests. The personal computing device 118 includes a processor 108 for executing an operating system (not shown) and one or more programs, such as the transit request application 104 that provides transit request data to the route planning system 112. The personal computing device 118 further includes communication circuitry for communicating across a wide-area network (WAN) (e.g., a cellular network such as 3G, 4G, LTE) or a local area network (LAN) (e.g., a Wi-Fi network, a BlueTooth network, radio communications network). Data transmission and receipt is accomplished using a receiver and transmitter (e.g., TX/RX 110).

In FIG. 1, the personal communication device 118 includes a location tracker 114 that obtains current positioning information for the personal communication device 118 and provides such information to the transit request application 104 and/or the route planning system 112. For example, the location tracker 114 may include a global positioning system (GPS) receiver for receiving geographical coordinates from GPS satellites. Additionally, and/or alternatively, the location tracker 114 may include hardware and/or software for communicating with other devices across a local area network (LAN). In some implementations, the personal communication device 118 does not include a location tracker 114. For example, the transit request application 104 may provide the route planning system 112 with rider location data by prompting the user to supply such information.

In some implementations, the personal computing device 118 automatically provides transit request data to the route planning system 112, such as based on detected movements of the personal computing device 118, time of data, calendar data (e.g., scheduled appointments), or data. In other implementations, transmission of transit request data is initiated by potential riders interacting with the transit request application 104. Transit request data may include any combination of user-provided inputs and automatic inputs, including without limitation information pertaining to requested pick-up or drop-off times or locations or other transit options.

FIG. 1 shows example user-provided inputs to the transit request 104 in a user interface 136. The information shown in the user interface 136 is meant to be exemplary and may, in other implementations, take on other forms and include other types of information in addition to or in lieu of that information shown. In general, inputs provided to the transit request application 104 are used to facilitate pick-up and/or drop-off of a potential rider at a given location, such as a location input by the potential rider or a location automatically provided by the location tracker 114. For example, the transit request application 104 may provide the potential rider with an option for selecting a pick-up time. In FIG. 1, the user interface 136 allows the rider to select between “soonest available” pick-up and a customized, user-specified “specific time,” such as to request a pick-up at a specific future time. In one implementation, the user interface 136 includes a single touch button that facilitates a single-touch request for the soonest available pick-up at a system-determined location (e.g., a current location indicated by the location tracker 114, a predesignated stop closest to the location indicated by the location tracker 114, a default pick-up location specified by a user profile, etc.).

The user may also provide the transit request application 104 with a requested drop-off location. In FIG. 1, the user supplies pick-up and drop-off locations by specifying a district from a drop-down menu (e.g., lower downtown), and then selecting one of a number of predesignated stops. In another implementation, the rider provides the user interface 126 with a specific address for pick-up and/or drop-off, such as address(es) that may or may not correspond to predesignated system stops. In still other implementations, a drop-off location is automatically provided to the route planning system 112 based on user data available on the personal computing device 118, such as calendar appointments, emails, reminders, etc.

In still other implementations, the transit request application 104 automatically determines any of the above-described inputs (e.g., pick-up or drop-off locations, times, user preferences) based on data available on the personal computing device 118, such as calendar appointments, emails, reminders, detected changes in location or detection patterns of changes to location (e.g., day-to-day patterns). In one implementation, the route planning system 112 determines a drop-off or pick-up location by identifying a predesignated stop location that is nearest to a location indicated by the transit request data.

The potential rider may provide the route planning system 112 with other transit options via the transit request application 104. For example, these transit options may be supplied in association with an individual rider transit request or supplied in association with a user profile. In one implementation, the potential rider specifies route planning options to request a route based on a shortest total time or shortest walk time (e.g., if there is an option to walk to multiple pick-up locations).

After the route planner 106 has identified a suitable route for fulfilling a particular request (e.g., either by planning a new route or identifying a potential modification to an existing route), the reservation intake engine 120 transmits a confirmation 134 to the personal computing device 118 that originated the rider transit request. For example, the confirmation 118 may include one or more of a confirmed pick-up location, vehicle identifier, an estimated pick-up time or pick-up window, and an estimated drop-off time or drop-off window. In one implementation, the user is provided with an estimated pick-up window and drop-off window. This window may be used as a constraint (e.g., saved within the route constraints 130) for the route planner 106 to ensure that any dynamically implemented changes to the route do not cause the estimated pick-up or drop-off times to slip outside of these windows.

In one implementation, the route planning system 112 supplies the transit request application 104 with updates regarding pick-up and/or drop-off times responsive to dynamically-implemented route changes. If, for example, a route change is implemented to pick-up an additional passenger at the cost of a three-minute detour, the transit request application may provide a notification to the associated user (e.g., a rider awaiting pick-up) to inform the user that the estimated pick-up time has slipped by three minutes. Notifications to provide updated drop-off times may be similarly provided.

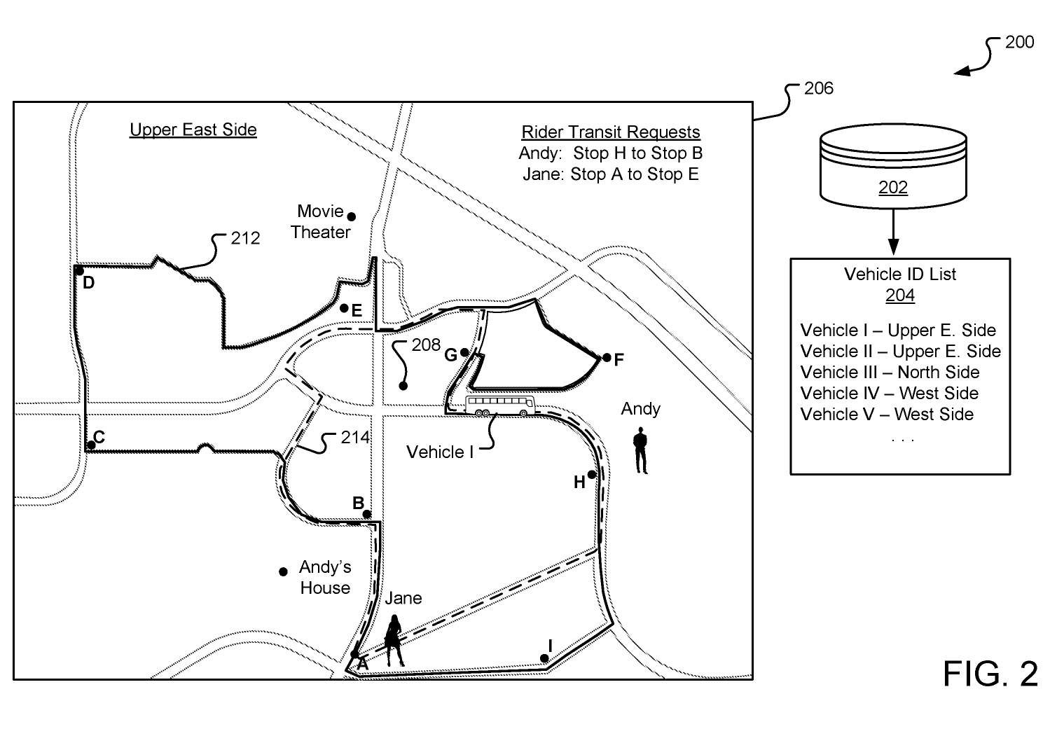

FIG. 2 illustrates route planning by an example demand-based transport system 200. In one implementation, the demand-based transport system 200 includes a server (not shown) that interacts with one or more personal computing devices to receive and respond to rider transit requests and to dynamically create customized transit routes and/or update existing transit routes responsive to receipt of such request(s). The demand-based transport 200 system includes a transport factor database 202 which may be a single database or multiple databases, either on a single network or distributed across any number of networks, servers, physical locations, etc.

The transport factor database 202 stores a vehicle identifier list 204 including transit vehicle identifiers in association with one or more geographic areas. For example, vehicles I-II are all associated with “Upper East Side” of a particular city, while vehicle III is associated with the “North Side,” and vehicles IV-V are associated with the “West Side” of the city. These associations generally identify regions where each vehicle is assigned to and/or available for dispatch. Such locations may, for example, be based on a storage location (e.g., parking garage) where the vehicle is docked at night or other criteria. In one implementation, vehicles are dynamically assigned to geographical areas based on rider demand. For example, each of vehicles I-V may be dynamically assigned to serve passengers in a particular geographical region based on real-time (current) demand as indicated by received rider transit requests.

In one implementation, the transport factor database 202 further stores a list (not shown) of predesignated drop-off/pick-up locations in association with each of a number of geographical areas. For example, the “Upper East Side” (shown in map 206) is associated with nine predesignated stop locations, labeled with alphabetical numerals A-I. The map 206 illustrates vehicle I at a starting location relative to a parking garage 208, where vehicle I is typically parked at night. In the illustrated example, vehicle I has been assigned to service in the upper east side of town. This assignment may be, for example, a default assignment that is in effect indefinitely, or a real-time (e.g., dynamic) assignment responsive to receipt of one or more rider transit requests for the Upper East Side.

A longest route 212 (shown by solid line) indicates an example route that may be followed to facilitate stops at each one of the predesignated stop locations 212. In the event that there exist concurrent rider transit requests specifying pick-up and/or drop-off at each one of these stops (e.g., A-I), the longest route 212 may represent a most time-effective route for servicing all predesignated stops A-I. However, at certain times of day, some of these stops are in high demand while others are scarcely requested. To compensate for this uneven demand for different stops, the demand-based transport system dynamically plans and/or updates each individual route based on current demand, as indicated by a volume of received rider transit requests.

In the illustrated example, two different potential riders place rider transit requests around the same time. A first potential rider, Andy, walks out of his office at 4:50 pm with the intent of catching a bus to his home. While walking to his usual pick-up stop at designated pick-up stop H, Andy uses a personal electronic device (e.g., a mobile phone) to place a rider transit request.

As discussed above with respect to FIG. 1, various methods for submitting a rider transit request may vary considerably in different implementations. Some methods may be entirely automated, while other are partially automated and/or dependent on receipt of specific user inputs. In an implementation where rider transit request is entirely automated, the user (e.g., Andy) may not affirmatively provide any inputs to a user interface. Rather, inputs to a route planner may be inferred by a transit request application on Andy's personal electronic device based on a variety of available information including without limitation user history, calendar data, detected device movements, profile preferences, and other device information. For example, Andy's transit request may be automatically generated and transmitted when the transit request application on his mobile phone detects that he has left his office building on a weekday between 4:30 pm and 5:00 pm.

In an implementation where rider transit request is partially automated, the user may provide some information (e.g., a destination) while other information is inferred by the transit request application, such as the requested pick-up location. For example, Andy may be presented with a screen that allows him to easily select between his own previous transit destinations or optionally provide a new destination. Still other implementations provide the user with an array of rich options for customizing a rider transit request.

In the illustrated example, Andy uses the touchscreen of his mobile phone to request a pick-up at stop H and a drop-off at stop B, which is close to his home. A route planner (not shown) of the dynamic demand-based transport system 200 receives Andy's transit request and immediately identifies vehicle I as available to service the request.

Around the same time that Andy is placing his transit request, Jane decides to go to a movie. She sees that the movie she is interested in seeing has a next showing that begins at 5:35 pm. Jane pulls out her mobile phone and uses a transit request application to initiate a pick-up request. In one implementation, Jane initiates the pick-up request by typing the name of the movie theater into a “destination” field on the transit request application. The transit request application identifies the predesignated stop location “E” as being the closest stop to the movie theater and auto-fills this stop as a requested drop-off location. Since the movie is starting in about 45 minutes, Jane requests a “soonest available” pick-up rather than arrange a pick-up for a future point in time.

In one implementation, the demand-based transport system 200 implements a rider constraint that ensures that a “soonest available” pick-up request also guarantees a soonest available drop-off time. This constraint may, for example, prevent Jane from stepping on a full bus destined to stop in many places when she could wait 5 minutes longer for an empty bus that could take her to her final destination in a shorter total amount of time.

The route planner of the demand-based transport system 200 receives Jane's rider transit request before vehicle I has dispatched to pick-up Andy from work. Based on these two requests, the dynamic demand-based transport system determines an optimal route 214 (shown by dotted lines). In one implementation, the optimal route 214 is determined using mapping data, rider factors (e.g., rider pick-up and drop-off times and locations, user preferences) and transport factors (e.g., current speeds, vehicle locations). One or more route constraints are imposed to ensure that the planned route mitigates travel time for the individual riders and/or balances the interest of reduced travel time against certain transport objectives, such as the objective of serving as many riders as possible without causing “impermissible” delay in the transport of any one rider. “Impermissible delays” may, for example, be stored as route constraints, such as a constraint that prohibits dynamic route changes that cause slippage in a rider pick-up or drop-off time in excess of a predefined threshold.

In one implementation, the optimal route 214 is determined by calculating a metric that minimizes travel-time (e.g., rider factor constraints) for both Andy and Jane, taking into account transport factors such as travel distance, speed limits, known traffic delays, etc. (e.g., transport factor constraints).

The dynamic demand-based transport system 200 determines estimated pick-up and drop-off times for both Andy and Jane and transmits a confirmation message to the transit request application of each of their personal devices. Andy's confirmation message confirms an estimated pick-up at stop H at 4:57 and a drop-off at stop B and 5:15, while Jane's confirmation message confirms an estimated pick-up at stop A at 5:05 and an arrival at stop E (near the movie theater) at 5:20. The confirmation message may further include a vehicle identifier, such as a bus number, license plate, vehicle descriptor, etc. In one implementation, the confirmation message further provides an estimated window for pick-up or drop-off. For example, Jane's estimated pick-up and drop-off times may be included with a message indicating that pick-up and drop-off times are subject to slip by up to a maximum of 15 minutes. In one implementation, the rider-based transport system 200 sends updated notifications to the transit request application on each rider device in the event that the estimated pick-up and/or drop-off times have slipped for some reason (such as unexpected traffic delays or dynamic route changes to pick up additional riders).

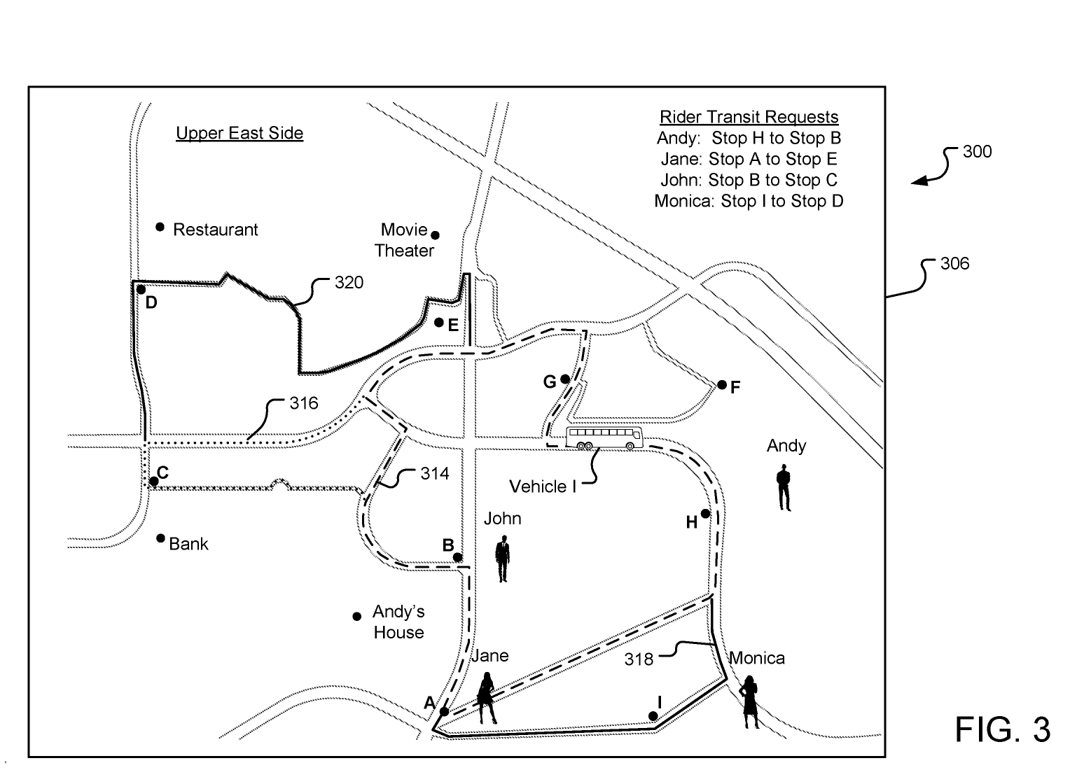

FIG. 3 illustrates dynamically-implemented route changes to a route planned by an example demand-based transport system 300. The demand-based transport system 300 may include the same or similar elements as those described with respect to FIGS. 1 and 2 above. In FIG. 3, the dynamic demand-based transport system 300 has planned an initial route 314 (e.g., an “optimal route”) in an Upper East Side of town (shown in map 306) responsive to receipt of rider transport requests from two potential riders, Andy and Jane. The Upper East Side of town includes nine predesignated stop locations, annotated A-I. Since there are initially no rider pick-up or drop-off requests pertaining to stop C, D, F, or I, the initial route 314 takes roads that bypass these locations completely to decrease passenger travel time.

In the illustrated example, Andy is traveling between stops H (near his office) and B (near his home), while Jane is traveling from stop A (near her home) to stop E (near the movie theater where she is going to see a show). Vehicle I has been dispatched to follow the initial route 314 and service Andy and Jane's rider transit requests.

When the vehicle I is in transit, a route planner of the dynamic demand-based transport system 300 receives another rider transit request from John. John is headed to the bank and requests a ride from predesignated stop B (near his home) to stop C (near the bank).

The dynamic demand-based transport system 300 receives John's rider transit request and immediately calculates a prospective route change (e.g., including route change segment 316) that would permit vehicle I to service's John request from stops B to C during the route currently in-progress. In calculating the prospective route change, the demand-based transport system may apply one or more metrics to account for time and/or distance minimization for each passenger individually and/or jointly, taking into account transport factors such as travel distance, speed limits, known traffic delays, etc. (e.g., transport factor constraints).

The route planner calculates prospective adjustments to previously-estimated pick-up and drop-off times for Andy and Jane. For example, the route planner determines that altering the initial route 314 to include the route change segment 316 does not affect Andy's pick-up or drop-off times, since Andy will be dropped off at stop B, which is the same stop where John is boarding the vehicle. While Jane's pick-up time at stop A is also not affected by the prospective route change, the newly-added stop at location C causes her initially-estimated drop-off time at stop E to slip by 5 minutes.

The route planner further determines whether altering the initial route 314 to include route change segment 316 violates any route constraints. For example, one route constraint may prevent certain directional changes causing vehicle I to make “circular” or round-about detours that frustrate riders. Another route constraint may, for example, limit the total amount of riders that may be serviced by a single route (e.g., to prevent overcrowding). Still another route constraint may limit the amount of “slippage time” in an estimated pick-up or drop-off that is due to a route change. For example, the dynamic demand-based transport system 300 may prohibit route changes that cause more than 15 minutes in slippage in an originally-estimated pick-up and/or drop-off for a rider that is already being serviced by a route in-progress. If this constraint is implemented in the above example where Jane's estimated drop-off time has slipped by 5 minutes due to the prospective route change, the demand-based transport system 300 may therefore determine that the calculated route change is acceptable.

Provided that altering the initial route 314 to include the route change segment 316 does not violate any route constraints, the in-progress route of vehicle I is modified to include the route change segment 316. Passengers affected by the change (e.g., Jane) may receive notifications via their personal electronic device indicating adjustment(s) to previously-provided estimated pick-up and drop-off times. Updated route information may also be transmitted to an on-board computer within Vehicle I to inform a driver of the modifications to the initial route.

When vehicle I is nearing stop H where Andy is waiting to be picked up, the route planner receives a request from Monica, who is waiting at stop I and wishes to be dropped off at stop D, where she is meeting a friend at a popular restaurant. The dynamic demand-based transport system calculates a second prospective route change modifying the in-progress route to include route change segments 318 and 320 in order to permit vehicle I to service's Monica's request from stop I to stop D during the in-progress route. In calculating this second prospective route change, the rider-drive transport system 300 again applies various metric(s) to account for time and/or distance minimization for each passenger individually and/or jointly, taking into account transport factors such as travel distance, speed limits, known traffic delays, etc. (e.g., transport factor constraints).

Upon calculating this potential route change, the dynamic demand-based transport system again calculates adjustments to previously-estimated pick-up and drop-off times for riders currently being serviced by the route in-progress. For example, the route planner determines that servicing Monica's request (e.g., stops H to D) induces a 5-minute delay in Jane's last-estimated pick-up time, a 12-minute delay in Jane's last-estimated drop-off time, a 5-minute delay in Andy's last-estimated drop-off time, and a five-minute delay in John's last-estimated pick-up and drop-off times. In this example, Jane is most affected by this prospective route change since the addition of stops at both I and D lengthen the route distance both prior to her embarkation at stop A and again after she has boarded vehicle I but prior to her disembarkation at stop E.

As mentioned above, some implementations of the demand-based transport system 300 may implement a route constraint that prohibits route changes that shift originally-estimated pick-up or drop-off times by more than a set time, such as 15 minutes. If such a constraint is implemented in the above-described example, the route planner may therefore determine that modification of the in-progress route to further include route change segments 318 and 320 causes Jane's originally-estimated drop-off time to slip by a total of 17 minutes (e.g., 5 minutes due to route changes to accommodate John and 12 minutes due to route changes to accommodate Monica). If the demand-based transport system 200 implements the above-described 15-minute slippage constraint, the route planner may reject the second proposed route change 318 to pick-up Monica due to the resulting unacceptable slippage in Jane's arrival time.

If the proposed route change to pick-up Monica is determined to be unacceptable, the dynamic demand-based transport system 300 may, for example, dispatch a second vehicle to service Monica's request. Alternatively, the dynamic demand-based transport system 300 may identify another vehicle currently servicing a route that may be dynamically updated to service Monica's request without violating any route constraints.

Notably, some implementations, may not implement “slippage” constraints and/or may implement various constraints based on other factors, such as “hard” arrival times (e.g., when the rider indicates that any slippage in arrival time is unacceptable) and route end constraints (e.g., if vehicle I is to be retired for the day by a set time).

Still other implementations of the disclosed technology provide for dynamic route alteration based on current passenger data that is received when the transportation vehicle is in-route along a planned route. Personal user devices may, for example, communicate information with each other and/or a computing device of a designated pick-up vehicle to indicate when each associate rider has boarded the designated pick-up vehicle. For example, a transit request application may access a local area network (e.g., BlueTooth) of the pick-up vehicle to confirm when a rider has boarded the vehicle. This way, if a particular rider requests pick-up but does not show up on-time to a designated pick-up location, the route planning system may automatically update the in-progress route to skip the drop-off location that no-show rider originally requested, provided there are no other riders that wish to be dropped-off or picked-up at that same location.

Still further implementations of the demand-based rider transport system 300 may permit dynamic modification of a transportation route to remove a planned stop responsive to cancellation of a rider pick-up request. For example, a rider may use a transit request application to cancel a requested pick-up. Responsive to such cancellation, the route planning system may dynamically alter the associated route to remove a planned stop associated with the canceled request and, if applicable, alter the route course to traverse a more direct route between stops requested by other passengers.

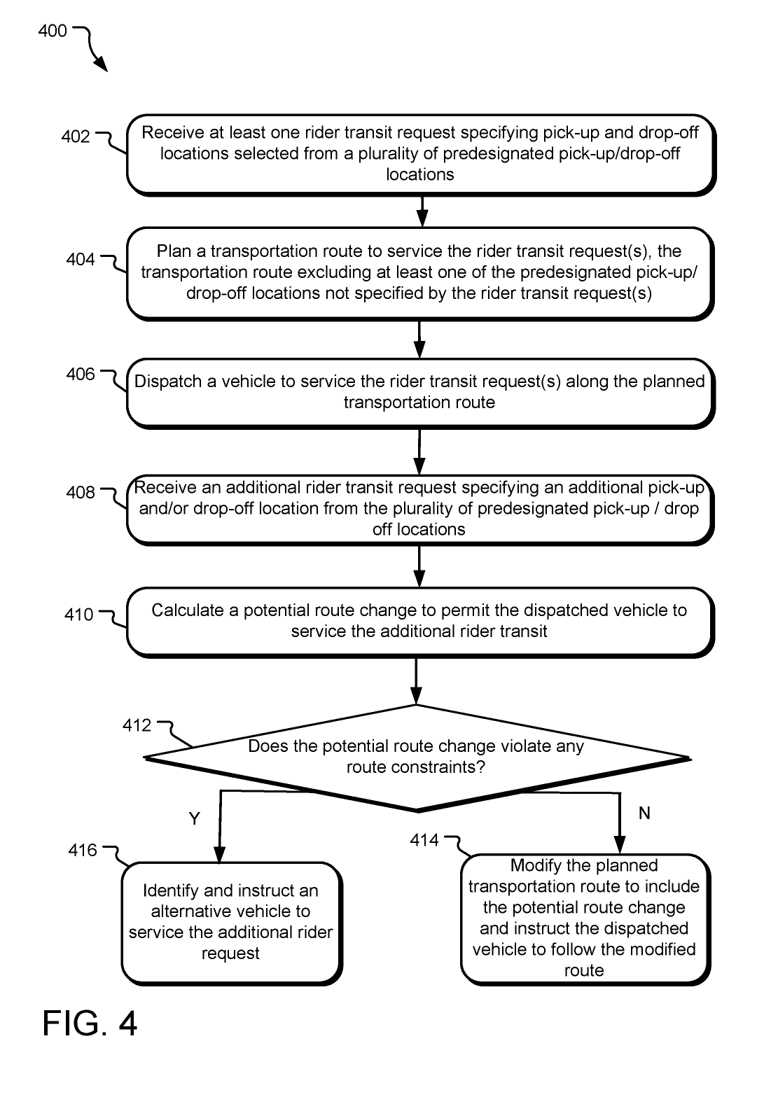

FIG. 4 illustrates example operations 400 for dynamic route planning according to an example demand-based transport system. A receiving operation 402 receives rider transit request(s) from computing devices each associated with a different user. In one implementation, each rider transit request specifies a pick-up location and a drop-off location that are selected from a plurality of predesignated stop locations. The rider transit request may be transmitted from a computing device either automatically or responsive to affirmative input from a user.

A planning operation 404 plans a customized transportation route to service the received rider transit request(s). The planned route is determined using a variety of available factors including, rider factors (e.g., requested times and locations for pick-up and drop-off as well as other rider preferences) and transport factors (e.g., current speeds, vehicle locations). Generation of the planned route may be further based on one or more route constraints imposed to ensure that the planned route mitigates travel time for the individual riders and/or balances the interest of reduced travel time against certain transport objectives, such as the objectives of serving as many riders as possible without causing unacceptable delay in the transport of any one rider, efficiently utilizing resources, etc. The planned route includes at least a pick-up and drop-off location for each associated rider. A planned route can service a single rider or multiple riders.

A dispatching operation 406 dispatches a vehicle to service the rider transit request(s) along the planned transportation route. In one implementation, the method further comprising transmitting confirmations to riders of the planned route to inform each rider of one or more of a vehicle identifier of the dispatched vehicle, estimated pick-up and/or drop-off times, and a pick-up and/or drop-off location.

While the dispatched vehicle is traversing the planned route, a receiving operation 408 receives an additional rider transit request specifying an additional pick-up location and a drop-off location that are both selected from the plurality of predesignated pick-up/drop-off locations. A calculation operation 410 calculates a potential route change that may permit the dispatched vehicle to service the additional rider transit request.

A determination operation 412 determines whether the potential route change violates any route constraints. Example route constraints include without limitation constraints designed prevent unacceptable slippage in estimated pick-up/drop-off times; constraints that limit the number of passengers to prevent overcrowding; constraints designed to prevent inefficient usage of resources; etc. If the determination operation 412 determines that the potential route change 412 does not violate any route constraints, an implementation operation 414 modifies the route to include the route change and instructs the dispatched vehicle to follow the modified route. For example, the dispatched vehicle may include a computing device (e.g., GPS unit, on-board computer, etc.) coupled to the demand-based route planning system that provides the driver with route information and receives real-time route changes from a route planner.

If, however, the determination operation 412 determines that the potential route change does violate one or more route constraints, an identification operation 416 identifies and instructs an alternative vehicle to service the additional rider request, such as by dispatching a new vehicle or by modifying an in-progress route of another nearby vehicle provided that such route modification can be implemented without violating any route constraints for the in-progress route.

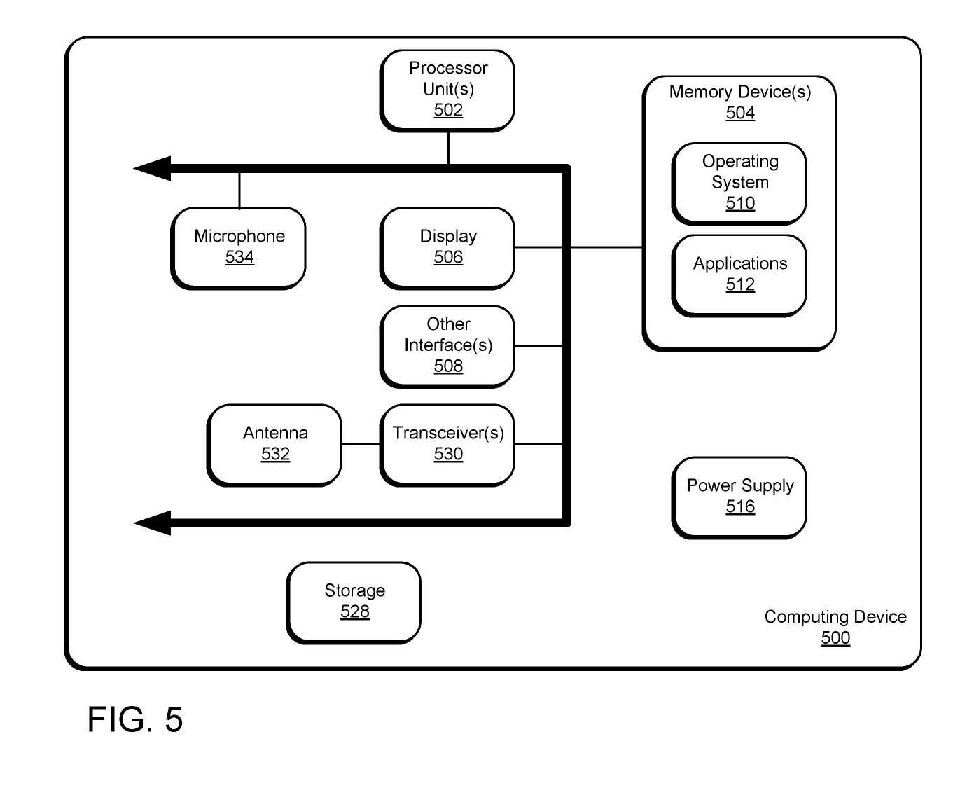

FIG. 5 illustrates an example schematic of a computing device 500 suitable for implementing aspects of a demand-based route transport system according to the herein described technology. The example computing device 500 includes one or more processor units 502, one or more memory devices 504, a display 506 (e.g., a touchscreen display or lights, a hardcopy output device such as a printer), and other interfaces 508 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory 504 and is executed by the processor unit(s) 502, although it should be understood that other operating systems may be employed.

One or more applications 512, such as programs to support placement of rider transit requests, reservation intake, and route planning are loaded in the memory device 504 and executed on the operating system 510 by the processor(s) 502.

The example computing device 500 includes a power supply 516, which is powered by one or more batteries or other power sources and which provides power to other components of the computing device 500. The power supply 516 may also be connected to an external power source that overrides or recharges the built-in batteries or other power sources.

The computing device 500 includes one or more communication transceivers 530 and an antenna 532 to provide network connectivity (e.g., a mobile phone network, Wi-Fi®, BlueTooth®, etc.). The computing device 500 may also include various other components, such as a positioning system (e.g., a global positioning satellite transceiver), one or more accelerometers, one or more cameras, an audio interface (e.g., a microphone 534, an audio amplifier and speaker and/or audio jack), and additional storage 528. Other configurations may also be employed.

In an example implementation, a mobile operating system, various applications and other modules and services may be embodied by instructions stored in memory 504 and/or storage devices 528 and processed by the processing unit(s) 502. Mapping data, current route data, rider factors, transport factors, route constraints and other data may be stored in memory 504 and/or storage devices 508 as persistent datastores.

The computing device 500 may include a variety of tangible computer-readable storage media and intangible computer-readable communication signals. Tangible computer-readable storage can be embodied by any available media that can be accessed by the speech recognition device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

A method comprises receiving one or more rider transit requests from a computing device and planning a transportation route with a processor responsive to receipt of the one or more rider transit requests. Each of the received rider transit requests specifies at least one stop request associated with one of a plurality of predesignated stop locations. The planned transportation route includes planned stops selected from the predesignated stop locations. The method further comprises transmitting the planned transportation route to a vehicle assigned to service an area including the planned transportation route.

In another example method of any preceding method, the planned stops exclude at least one of the predesignated stop locations not associated with any of the one or more rider transit requests.

In another example method of any preceding method, planning the transportation route further comprises planning the transportation route based on at least one transport factor of a transportation vehicle, one or more rider factors associated with the pick-up requests, and one or more predetermined route constraints.

In another example method of any preceding method, the transportation route is based on drop-off locations specified in association with each of the one or more rider transit requests and the planned stops correspond to the specified drop-off locations.

In another example method of any preceding method, the transportation route includes a route course that avoids one or more of the predesignated stop locations that do not correspond to the planned stops.

In another example method of any preceding method, the method further comprises receiving an additional rider transit request specifying another one of the predesignated stop locations not corresponding to any of the planned stops in the transportation route and dynamically modifying the transportation route to add a planned stop at the stop location specified by the additional rider transit request.

In another example method of any preceding method, the method further comprises receiving an additional rider transit request specifying a stop location that does not correspond to any of the predesignated stop locations after the transportation route is initially planned and dynamically modifying the transportation route to add a planned stop at the stop location specified by the additional rider transit request.

In another example method of any preceding method, the method further comprises dynamically altering the transportation route to skip one of the planned stops based on current passenger data received while an associated transportation vehicle is servicing the transportation route.

In another example method of any preceding method, the method further comprises transmitting a confirmation to a computing device associated with each of the one or more rider transit requests, the confirmation specifying a pick-up time and a pick-up location.

A system comprises memory, a processor, and a reservation intake engine stored in memory and executable by the processor to receive one or more rider transit requests from a computing device that specifies at least one stop request associated with one of a plurality of predesignated stop locations. The system further comprises a route planner stored in memory and executable by the processor to plan a transportation route responsive to receipt of the one or more rider transit requests, where the transportation route includes planned stops selected from the predesignated stop locations.

In another example system of any preceding system, the planned stops exclude at least one of the predesignated stop locations not associated with any of the one or more rider transit requests.

In another example system of any preceding system, the route planner is further executable to plan the transportation route based on at least one transport factor of a transportation vehicle, one or more rider factors associated with the pick-up requests, and one or more predetermined route constraints.

In another example system of any preceding system, the reservation intake engine is further executable to receive an additional rider transit request after the transportation route is initially planned that specifies another one of the predesignated stop locations not corresponding to any of the planned stops in the transportation route. The route planner is further executable to dynamically modify the transportation route to add a planned stop at the stop location specified by the additional rider transit request.

In another example system of any preceding system, the reservation intake engine is further executable to receive an additional rider transit request after the transportation route is initially planned that specifies a stop location not corresponding to any of the predesignated stop locations, and wherein the route planner is further executable to dynamically modify the transportation route to add a planned stop at the stop location specified by the additional rider transit request.

In another example system of any preceding system, the route planner is further executable to dynamically alter the transportation route to skip one of the planned stops based on current passenger data received when an associated transportation vehicle is servicing the transportation route.

In still another example system of any preceding system, the reservation intake engine is further executable to transmit a confirmation to a computing device associated with each one of the one or more rider transit requests, the confirmation specifying a pick-up time and a pick-up location.

In another example system of any preceding system, the confirmation further specifies an estimated arrival time.

In another example system of any preceding system, the route planner is constrained from dynamically implementing a route change that moves the estimated arrival time outside of the arrival time window.

One or more computer-readable storage media of a tangible article of manufacture encoding computer-executable instructions for executing on a computer system a computer process comprising receiving one or more rider transit requests and planning a transportation route responsive to receipt of the one or more rider transit requests. Each of the rider transit requests is received from a computing device and specifies at least one stop request associated with one of a plurality of predesignated stop locations. The transportation route includes planned stops selected from the predesignated stop locations. The computer process further comprises transmitting the planned transportation route to a vehicle assigned to service an area including the planned transportation route.

In another computer-readable media of any preceding computer-readable media, the encoded computer process further comprises receiving an additional rider transit request after the transportation route is initially planned. The additional rider transit request specifies a new one of the predesignated stop locations not corresponding to any of the planned stops in the transportation route. The process further comprises determining whether a route alteration to include a stop at the newly-specified stop location violates a predetermined route constraint; and if the route alteration does not violate the predetermined route constraint, dynamically modifying the transportation route to add a planned stop at the stop location specified by the additional rider transit request.

In another computer-readable media of any preceding computer-readable media, the predetermined route constraint is violated if the route alteration is estimated to cause a change in an estimated pick-up or drop-off time for one or more passengers in excess of a predetermined threshold.

In another computer-readable media of any preceding computer-readable media, the encoded computer process further comprises dynamically modifying the transportation route to remove a planned stop responsive to cancellation of a rider transit request after the transportation route is initially planned.

One example system for planning transportation route includes a means for receiving one or more rider transit requests, each of the rider transit requests received from a computing device and specifying at least one stop request associated with one of a plurality of predesignated stop locations. The system further comprises a means for planning a transportation route with a processor responsive to receipt of the one or more rider transit requests, where the transportation route includes planned stops selected from the predesignated stop locations. The system further comprises a means for transmitting the planned transportation route to a vehicle assigned to service an area including the planned transportation route.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

1. A method comprising:
receiving one or more rider transit requests, each of the rider transit requests received from a computing device and specifying at least one stop request identifying one of a plurality of predesignated stop locations preassigned to a vehicle;
planning a transportation route with a processor responsive to receipt of the one or more rider transit requests, the transportation route including one or more planned stops selected from the predesignated stop locations; and
transmitting the planned transportation route to the vehicle.

2. The method of claim 1, wherein the planned stops exclude at least one of the predesignated stop locations not associated with any of the one or more rider transit requests.

3. The method of claim 1, wherein planning the transportation route further comprises planning the transportation route based on at least one transport factor of a transportation vehicle, one or more rider factors associated with the pick-up requests, and one or more predetermined route constraints.

4. The method of claim 1, wherein the transportation route is based on drop-off locations specified in association with each of the one or more rider transit requests and the planned stops correspond to the specified drop-off locations.

5. The method of claim 1, wherein the transportation route includes a route course that avoids one or more of the predesignated stop locations that do not correspond to the planned stops.

6. The method of claim 1, further comprising:
after the transportation route is initially planned, receiving an additional rider transit request specifying another one of the predesignated stop locations not corresponding to any of the planned stops in the transportation route; and
dynamically modifying the transportation route to add a planned stop at the stop location specified by the additional rider transit request.

7. The method of claim 1, further comprising:
after the transportation route is initially planned, receiving an additional rider transit request specifying a stop location that does not correspond to any of the predesignated stop locations; and
dynamically modifying the transportation route to add a planned stop at the stop location specified by the additional rider transit request.

8. The method of claim 1, further comprising:
dynamically altering the transportation route to skip one of the planned stops based on current passenger data received while an associated transportation vehicle is servicing the transportation route.

9. The method of claim 1, further comprising:
transmitting a confirmation to the computing device associated with each of the one or more rider transit requests, the confirmation specifying a pick-up time and a pick-up location.

10. A system comprising:
memory;
a processor;
a reservation intake engine stored in memory and executable by the processor to receive one or more rider transit requests, each pick-up request received from a computing device and specifying at least one stop request identifying one of a plurality of predesignated stop locations preassigned to a vehicle;
a route planner stored in memory and executable by the processor to plan a transportation route and transmit the planned route to the vehicle responsive to receipt of the one or more rider transit requests, the transportation route including one or more planned stops selected from the predesignated stop locations.

11. The system of claim 10, wherein the planned stops exclude at least one of the predesignated stop locations not associated with any of the one or more rider transit requests

12. The system of claim 10, wherein the reservation intake engine is further executable to receive an additional rider transit request after the transportation route is initially planned, the additional rider transit request specifying another one of the predesignated stop locations not corresponding to any of the planned stops in the transportation route, and wherein the route planner is further executable to dynamically modify the transportation route to add a planned stop at the stop location specified by the additional rider transit request.

13. The system of claim 10, wherein the reservation intake engine is further executable to receive an additional rider transit request after the transportation route is initially planned, the additional rider transit request specifying a stop location not corresponding to any of the predesignated stop locations, and wherein the route planner is further executable to dynamically modify the transportation route to add a planned stop at the stop location specified by the additional rider transit request.

14. The system of claim 10, wherein the route planner is further executable to dynamically alter the transportation route to skip one of the planned stops based on current passenger data received when an associated transportation vehicle is servicing the transportation route.

15. The system of claim 10, wherein the reservation intake engine is further executable to:
transmit a confirmation to the computing device associated with each one of the one or more rider transit requests, the confirmation specifying a pick-up time and a pick-up location.

16. The system of claim 15, wherein the route planner is constrained from dynamically implementing a route change that moves an estimated arrival time outside of the arrival time window.

17. One or more computer-readable storage media of a tangible article of manufacture encoding computer-executable instructions for executing on a computer system a computer process, the computer process comprising:
receiving one or more rider transit requests, each rider transit request received from a computing device and specifying at least one stop request identifying at least one of a plurality of predesignated stop locations preassigned to the vehicle;
planning a transportation route responsive to receipt of the one or more rider transit requests, the transportation route including one or more planned stops selected from the predesignated stop locations; and
transmitting the planned transportation route to the vehicle.

18. The one or more computer-readable storage media of claim 17, wherein the computer process further comprises:
after the transportation route is initially planned, receiving an additional rider transit request specifying a new one of the predesignated stop locations not corresponding to any of the planned stops in the transportation route; and
determining whether a route alteration to include a stop at the newly-specified stop location violates a predetermined route constraint;
if the route alteration does not violate the predetermined route constraint, dynamically modifying the transportation route to add a planned stop at the stop location specified by the additional rider transit request.

19. The one or more computer-readable storage media of claim 17, wherein the predetermined route constraint is violated if the route alteration is estimated to cause a change in an estimated pick-up or drop-off time for one or more passengers in excess of a predetermined threshold.

20. The one or more computer-readable storage media of claim 17, further comprising:
after the transportation route is initially planned, dynamically modifying the transportation route to remove a planned stop responsive to cancellation of a rider transit request.

21. The method of claim 1, wherein the at least one stop request specifies a planned stop selected from the plurality of predesignated stop locations.
